(19) United States
(12) Patent Application Publication
(10) Pub. No.: US 2021/0195041 A1
(43) Pub. Date: Jun. 24, 2021

(54) IMAGE FORMING APPARATUS AND INFORMATION TRANSMISSION METHOD

(71) Applicant: TOSHIBA TEC KABUSHIKI KAISHA, Tokyo (JP)

(72) Inventors: Norikazu OCHIAI, Izu Shizuoka (JP); Tomoaki IDE, Fuji Shizuoka (JP)

(73) Assignee: TOSHIBA TEC KABUSHIKI KAISHA, Tokyo (JP)

(21) Appl. No.: 16/905,754

(22) Filed: Jun. 18, 2020

(30) Foreign Application Priority Data
Dec. 23, 2019 (JP) 2019-231032

(51) Int. Cl. H04N 1/00; G06F 3/16

(52) U.S. Cl. CPC H04N 1/00403; G06F 3/167; H04N 1/00891

(57) ABSTRACT

An image forming apparatus includes a voice input interface, a controller, and a communication interface. The voice input unit is configured to receive a voice in the vicinity of the image forming apparatus as an input and output a voice signal indicating the voice. The controller is configured to record the voice signal output during a predetermined first period as voice data. The controller is configured to acquire related data acquired in a second period determined according to the first period. The communication interface is configured to transmit the related data and the voice data to another apparatus.

### CROSS-REFERENCE TO RELATED APPLICATION

This application is based upon and claims the benefit of priority from Japanese Patent Application No. 2019-231032, filed Dec. 23, 2019, the entire contents of which are incorporated herein by reference.

### FIELD

Embodiments described herein relate generally to an image forming apparatus and an information transmission method.

### BACKGROUND

A complaint or request regarding the use of an image forming apparatus is received when a user calls a department such as a contact center. However, in such a method, it may take time to make a call, or a long waiting time may be required before a connection to an operator is made. For that reason, in some cases, the user spares such time and effort, or the user has a complaint or a request regarding the apparatus, but does not communicate the complaint or the request to a manufacturer while enduring the complaint or request. As a method for solving such a problem, an image forming apparatus capable of inputting a user complaint or request as voice data is developed.

### DESCRIPTION OF THE DRAWINGS

FIG. 1 is a diagram illustrating an image forming apparatus according to some embodiments;

FIG. 2 is an external view illustrating a configuration example of the image forming apparatus according to some embodiments;

FIG. 3 is a diagram illustrating an example of a hardware configuration of the image forming apparatus according to some embodiments;

FIG. 4 is a diagram illustrating a configuration of a voice input unit, a display, and a control panel according to some embodiments;

FIG. 5 is a flowchart illustrating a first example of a process in which a controller transmits voice data and related data to a support center in the image forming apparatus according to some embodiments;

FIG. 6 is a flowchart illustrating a second example of the process in which the controller transmits the voice data and the related data to the support center in the image forming apparatus according to some embodiments;

FIG. 7 is a flowchart illustrating a third example of the process in which the controller transmits voice data and the related data to the support center in the image forming apparatus according to some embodiments;

FIG. 8 is a flowchart illustrating a fourth example of the process in which the controller transmits the voice data and the related data to the support center in the image forming apparatus according to some embodiments;

FIG. 9 is a diagram illustrating a configuration example of an image forming apparatus according to some embodiments; and

FIG. 10 is a flowchart illustrating an example of a process in which a controller transmits voice data and related data to a support center in the image forming apparatus in some embodiments.

### DETAILED DESCRIPTION

According to some image forming apparatuses, a user can easily communicate a request or a complaint while using the apparatus to the manufacturer's side. However, although it is possible to promptly receive the user complaint or request, it is not always possible to obtain information necessary for coping with the complaint or request. For that reason, it takes time to investigate and analyze the received complaint or request and it is not possible to respond promptly, in some cases.

Embodiments herein provide an image forming apparatus and an information transmission method capable of linking information for promptly responding to a user request or complaint regarding the use of the apparatus.

In general, according to some embodiments, there is provided an image forming apparatus including a voice input unit (e.g., a voice receiver), a recording unit (e.g., a recorder), and a control unit (e.g., a controller). The voice input unit is configured to receive a voice around its own apparatus as an input and output a voice signal indicating the voice. The recording unit is configured to record the voice signal output during a predetermined first period as voice data. The control unit is configured to acquire related data acquired in a second period determined according to the first period and transmit the related data and the voice data to another apparatus.

Hereinafter, an image forming apparatus and an information transmission method according to a first embodiment will be described with reference to the accompanying drawings.

### First Embodiment

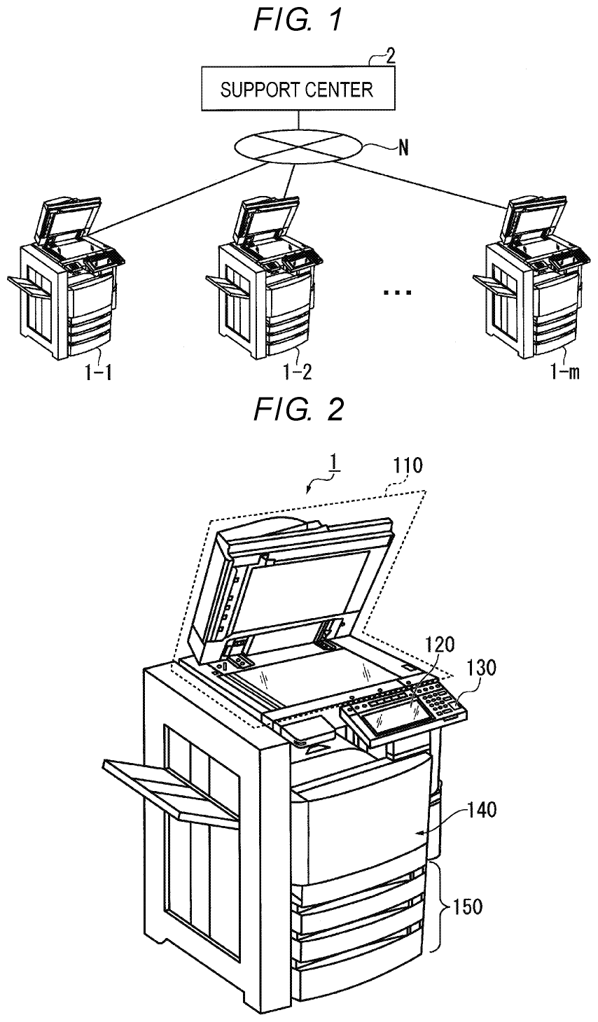

FIG. 1 is a diagram illustrating an example of an image forming apparatus 1 according to the first embodiment. Specifically, FIG. 1 illustrates a support system 100 including one or more image forming apparatuses 1 and a support center 2 as an example. The support system 100 illustrated in FIG. 1 includes image forming apparatuses 1-1 to 1-m (m is an integer of 1 or more) as one or more image forming apparatuses 1. For example, the image forming apparatus 1 may be a multi-function peripheral (MFP). The support system 100 is a system that links a user complaint and request regarding the image forming apparatus 1 to the support center 2. The image forming apparatus 1 is communicably connected to the support center 2 via a network N. The image forming apparatus 1 has a function of inputting a user complaint or request as voice data, and a function of transmitting the input voice data to the support center 2. The support center 2 is a system that receives a user inquiry about the image forming apparatus 1, and is a system operated by a manufacturer of the image forming apparatus 1. The support center 2 performs a necessary investigation on the received inquiry, and links information such as an investigation result and a response method to the user as necessary. By configuring the image forming apparatus 1 as a part of such a support system 100, a user can easily communicate a complaint or a request regarding the image forming apparatus 1 to the manufacturer's side.

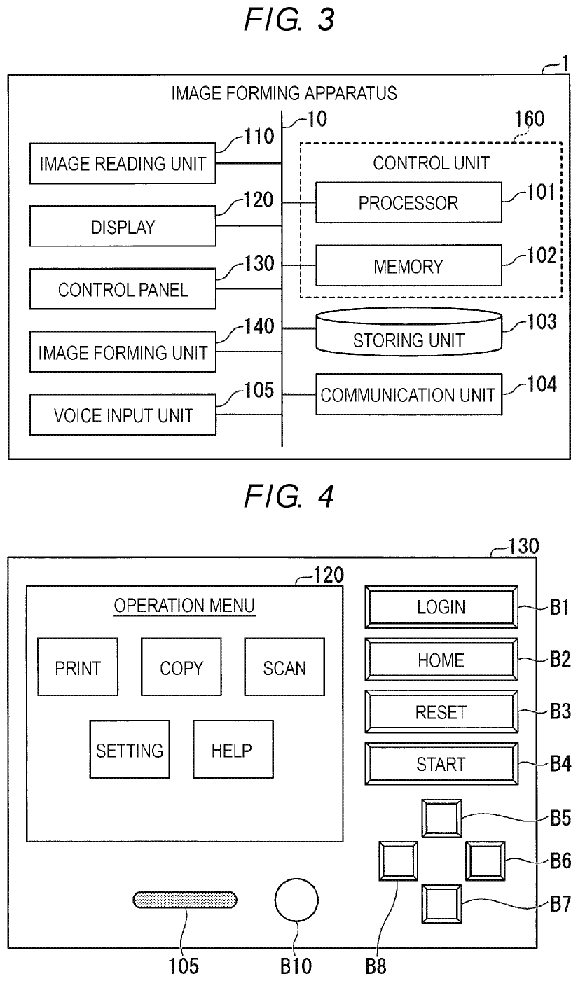

FIG. 2 and FIG. 3 are diagrams illustrating example configurations of the image forming apparatus 1 according to the first embodiment. FIG. 2 illustrates an example appearance of the image forming apparatus 1, and FIG. 3 illustrates an example hardware configuration diagram of the image forming apparatus 1. The image forming apparatus 1 forms an image on a sheet using a developer such as a toner or ink. When the developer is a toner, the developer is fixed on the sheet by heating. When the developer is ink, the developer is dropped on the sheet to form an image on the sheet. The sheet is, for example, paper or label paper. The sheet may be any matter as long as the image forming apparatus 1 can form an image on the sheet's surface. The toner may be a decolorable toner that is decolorable at a predetermined temperature.

Specifically, the image forming apparatus 1 includes a processor 101, a memory 102, and a storing unit 103 connected by a bus 10. For example, the processor 101 is a central processing unit (CPU). The memory 102 functions as a main storage device, and is configured using a semiconductor storage device such as a dynamic random access memory (DRAM) or a static random access memory (SRAM). The storing unit 103 functions as an auxiliary storage device, and is configured using a magnetic storage device such as a hard disk drive (HDD) or a semiconductor storage device such as a solid state drive (SSD).

The image forming apparatus 1 reads a program recorded in the storing unit 103 into the memory 102, and executes the read program by the processor 101. This program is executed, thereby allowing the processor 101 and the memory 102 to function as a control unit 160 (e.g., a controller) that controls an operation of the image forming apparatus 1. The image forming apparatus 1 includes the controller 160, thereby functioning as an apparatus including a communication unit 104, a voice input unit 105, an image reading unit 110, a display 120, a control panel 130, and an image forming unit 140.

All or a part of functional units included in the image forming apparatus 1 may be implemented using hardware such as an application specific integrated circuit (ASIC), a programmable logic device (PLD), or a field programmable gate array (FPGA). The program may be recorded on a computer-readable recording medium in addition to the storing unit 103. The computer-readable recording medium is a portable medium such as a flexible disk, a magneto-optical disk, a ROM, and a CD-ROM. The program may be transmitted via a telecommunication line.

The communication unit 104 is configured using a communication interface. The communication unit 104 communicates with another apparatus (for example, an information terminal such as a personal computer) via a network N such as LAN. For example, the communication unit 104 communicates information such as print data and scanner data with a user terminal. The print data includes image information to be subjected to image formation. The scanner data is image information read by the image reading unit 110.

The voice input unit 105 is configured using a voice input device (e.g., an audio receiver/voice receiver) such as a microphone, which obtains first voice data of a voice when a speaker is within a vicinity of the image forming apparatus. The voice input unit 105 outputs second voice data indicating the input voice to the controller 160. The voice data is transmitted to the support center 2 via the communication unit 104. The voice data may be recorded in the storing unit 103 by a sound recorder.

The image reading unit 110 is, for example, a scanner. The image reading unit 110 reads image information to be read as lightness and darkness of light. The image reading unit 110 records the read image information. The recorded image information may be stored in the storing unit 103 of the image forming apparatus 1, or may be transmitted to another information processing apparatus via the communication unit 104. The recorded image information may be image-formed on a sheet by the image forming unit 140.

The display 120 is an image display device such as a liquid crystal display or an organic electroluminescence (EL) display. The display 120 displays various types of information relating to the image forming apparatus 1.

The control panel 130 includes a plurality of buttons. The control panel 130 receives a user operation. The control panel 130 outputs a signal corresponding to the operation performed by the user to the controller 160. The display 120 and the control panel 130 may be configured as an integrated touch panel.

The image forming unit 140 forms an image on the sheet based on image information generated by the image reading unit 110 or received image information. The image forming unit 140 includes, for example, a developing device, a transfer device, and a fixing device. A sheet conveyance path is formed in the image forming unit 140. The sheet to be processed is conveyed by rollers provided in a transport path. An image is formed on the sheet in the course of conveyance.

The image forming unit 140 forms an image by the following process, for example. The developing device of the image forming unit 140 forms an electrostatic latent image on a photoreceptor drum based on the image information. The developing device of the image forming unit 140 forms a visible image by adhering developer to the electrostatic latent image.

The transfer device of the image forming unit 140 transfers the visible image onto the sheet. The fixing device of the image forming unit 140 fixes the visible image on the sheet by heating and pressing the sheet. The sheet on which an image is formed may be a sheet stored in a sheet storage unit 150 or a manually inserted sheet. The sheet storage unit 150 stores the sheet used for image formation in the image forming unit 140.

The controller 160 controls an operation of each device provided in the image forming apparatus 1. For example, upon receiving an instruction to form an image from a user terminal, the controller 160 may control its own apparatus to form an image corresponding to the received instruction on a sheet. For example, upon receiving an image reading instruction from the user terminal, the controller 160 may control its own apparatus to transmit data of the image read by the image reading unit 110 to the user terminal that is a transmission source of the instruction.

In the image forming apparatus 1 of the embodiment, the controller 160 has a function of transmitting input voice data to the support center 2 according to a voice input operation by the user. Specifically, the controller 160 transmits the voice data of the user to support center 2 according to a specific operation input to the control panel 130. For that reason, in the image forming apparatus 1 of the embodiment, the control panel 130 includes an input interface for inputting the specific operation (hereinafter, referred to as a “specific operation interface”) described above. For example, the control panel 130 includes a request button illustrated in FIG. 4 as an example of the specific operation interface, where the request button (which may be a switch, as discussed below) serves as an aspect of an input interface.

FIG. 4 is a diagram illustrating a configuration example of the voice input unit 105, the display 120, and the control panel 130. For example, on the display 120, various operation menus for using the image forming apparatus 1 are displayed. Further, the control panel 130 is provided with various buttons B1 to B8 for the user to input operations such as selection and execution on the operation menu. In this case, the controller 160 detects the presence or absence of an operation on each button based on the output signal of the control panel 130, and identifies an operation performed on the operation menu based on an input state of each button. The controller 160 causes each function unit to perform an operation corresponding to the identified input operation, so that various functions of the image forming apparatus 1 are implemented.

Furthermore, the control panel 130 is provided with a request button B10 for a user to notify the support center 2 of a request or complaint regarding the image forming apparatus 1 by a voice message. In this case, the controller 160 detects the presence or absence of an operation on the request button B10 based on an output signal of the control panel 130, and acquires voice data to be transmitted to the support center 2 based on an input state of the request button B10. By providing the image forming apparatus 1 with such a configuration, the user can communicate the request or complaint regarding the image forming apparatus 1 to a manufacturer's side without calling a support department.

Furthermore, the controller 160 has a function of transmitting related data and voice data. The related data is data stored in the image forming apparatus 1, and is data acquired at a timing corresponding to the input timing of the voice data. The related data may be any data as long as the data contributes to coping with the notified user request or complaint on the manufacturer's side. For example, the related data may include various types of log information stored in the image forming apparatus 1, or may include information indicating an input operation performed by the user. By transmitting such related data and voice data to the support center 2, on the manufacturer's side, it is possible to more promptly address the user request or complaint.

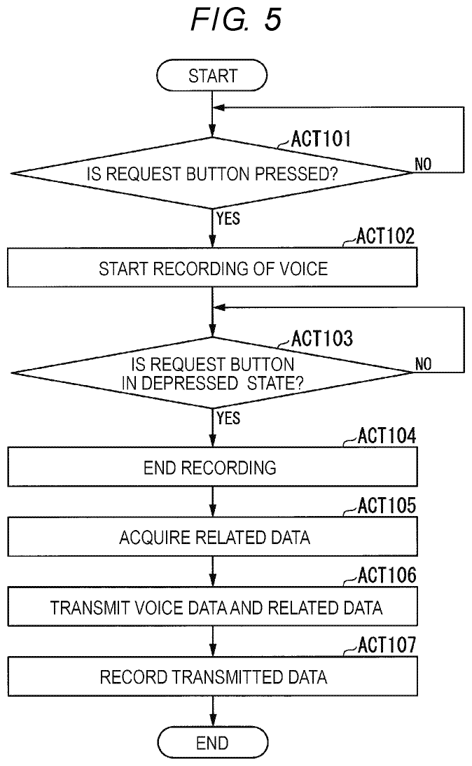

FIG. 5 is a flowchart illustrating a first example of a process in which the controller 160 transmits the voice data and the related data to the support center 2 in the image forming apparatus 1 according to the first embodiment. First, the controller 160 determines whether or not an input of an operation of depressing the request button is detected (ACT 101). When it is determined that the input of the operation is not detected (NO in ACT 101), the controller 160 repeatedly executes ACT 101 until the input of the operation is detected.

On the other hand, when it is determined that the input of the operation is detected (YES in ACT 101), the controller 160 starts recording the voice input by the voice input unit 105 (ACT 102). Specifically, the controller 160 starts recording the voice data in the storing unit 103 at this timing.

Subsequently, the controller 160 determines whether or not the request button is in a depressed state (ACT 103). When it is determined that the request button is in the depressed state (YES in ACT 103), the controller 160 repeatedly executes ACT 103 until the request button is no longer depressed.

On the other hand, when it is determined that the request button is not in the depressed state (NO in ACT 103), the controller 160 ends the recording started in ACT 102 (ACT 104). Specifically, at this timing, the controller 160 ends the recording of the voice data in storing unit 103.

This operation allows the voice data input to be recorded while the request button is depressed in the storing unit 103. According to such a recording method, the user can easily communicate a request or complaint regarding the image forming apparatus 1 to the support center 2 at any time by depressing the request button. According to such a recording method, when the user does not depress the request button voice data input is not recorded. For that reason, it is possible to suppress the size of the voice data transmitted to the support center 2 such that the voice data does not become excessively large.

Such a recording method is an example, and the start or end of a recording period may be determined by another method. For example, the controller 160 may be configured to determine the start timing and the end timing of recording by depressing the request button once (not keeping the request button depressed) at each timing. Further, a request button for inputting the start timing of recording and a request button for inputting the end timing of recording may be separately provided.

Instead of the request button described above, in some embodiments, another specific operation interface may be provided. For example, the request button may be configured as a switch that switches between ON and OFF. In this case, the timing at which the request button is switched to ON may be determined as the start timing of recording, and the timing at which the request button is switched to OFF may be determined as the end timing of recording.

Subsequently, the controller 160 acquires the related data (ACT 105). As described above, the related data is data acquired at a timing corresponding to the input timing of the voice data. For that reason, it is assumed that the controller 160 records the timing at which the recording is started in ACT 102 and the timing at which the recording is ended in ACT 104. Here, the controller 160 may acquire, as related data, data acquired at any timing (hereinafter, referred to as “related timing”) determined according to the start timing or the end timing of recording. For example, the controller 160 may acquire data acquired during the recording of voice data as the related data. Further, for example, the controller 160 may acquire data acquired in a predetermined period including the recording period as the related data.

The controller 160 may acquire the related data by extracting data at the related timing from information that is continuously acquired. The controller 160 may acquire, as the related data, information whose acquisition is started by a predetermined operation. For example, in this case, the controller 160 may start acquisition of the related data at the start timing of recording, and end acquisition of the related data at a timing determined according to the end timing of recording. The controller 160 transmits the acquired voice data and related data to the support center 2 (ACT 106). The controller 160 stores the transmitted voice data and related data in the storing unit 103 in association with the data transmission timing, the recording timing, the related timing, and the like (ACT 107).

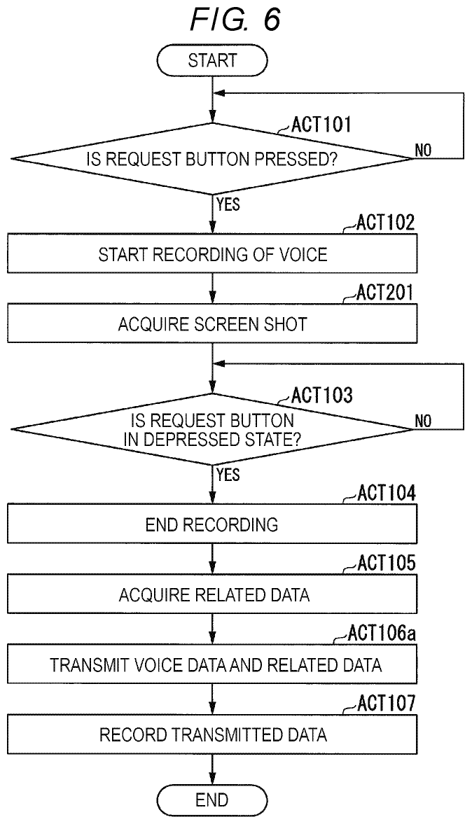

FIG. 6 is a flowchart illustrating a second example of the process in which the controller 160 transmits the voice data and the related data to the support center 2 in the image forming apparatus 1 according to the first embodiment. In FIG. 6, the same processes as those in the first flowchart are denoted by the same reference numerals as those in FIG. 5, and the description of the same processes will be omitted.

The second flowchart is different from the first flowchart in that the controller 160 acquires a screen shot of a screen displayed on the display 120 at the start of recording (ACT 201). The second flowchart is different from the first flowchart in that the controller 160 transmits the screen shot acquired at the start of recording to the support center 2 as a part of the related data (ACT 106a).

As described above, by transmitting the screen shot at the start of recording as the related data, on the manufacturer's side, it becomes possible to consider a more accurate response to the received request or complaint. For example, the timing at which the user intends to communicate a request or a complaint is highly likely to be the timing at which some malfunction occurs during the operation of the image forming apparatus 1 by the user. At that timing, an occurrence situation of the malfunction may be displayed on the display 120, and such a situation may not always be grasped from the log information. For that reason, the screen shot indicating the latest operation situation of the user is transmitted as the related data, so that the occurrence situation of the malfunction can be analyzed on the manufacturer's side. In this case, the screen shot does not necessarily need to be acquired at the timing at which the recording is started, and may be acquired at any related timing.

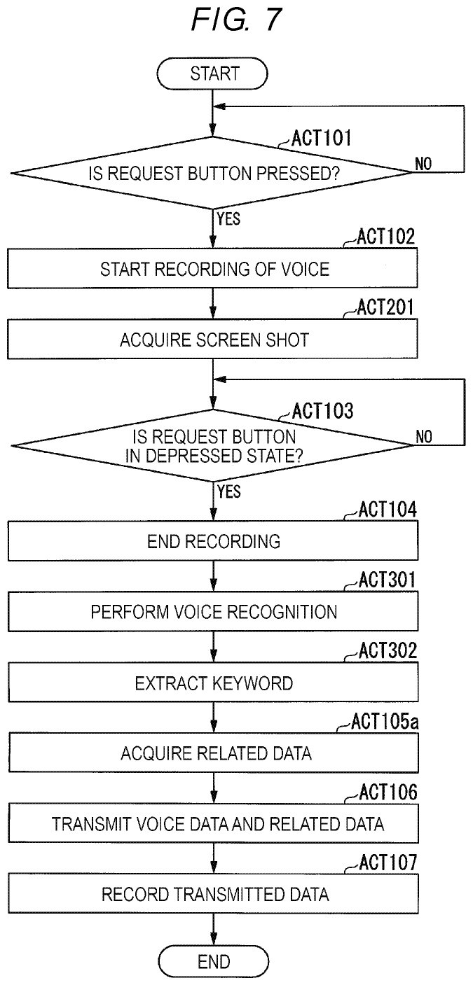

FIG. 7 is a flowchart illustrating a third example of the process in which the controller 160 transmits the voice data and the related data to the support center 2 in the image forming apparatus 1 according to the first embodiment. In FIG. 7, the same processes as those in the first or second flowchart are denoted by the same reference numerals as those in FIG. 5 or FIG. 6, and the description of the same processes will be omitted.

The third flowchart is different from the first or second flowchart in that the controller 160 performs voice recognition of the acquired recorded data (ACT 301). Specifically, the controller 160 converts the voice data into text data indicating the content of the voice. Any voice analysis technology may be used for this voice recognition.

The third flowchart is different from the second flowchart in that the controller 160 extracts a keyword for acquiring the related data from the converted text data (ACT 302). For example, the controller 160 extracts a keyword by determining whether or not a keyword assumed in advance is included in the text data. In this case, it is assumed that information indicating the keyword is stored in the storing unit 103 in advance.

The third flowchart is different from the first or second flowchart in that the related data is acquired based on the keyword extracted from the text data (ACT 105a). For example, the controller 160 identifies target data to be acquired as the related data based on correspondence information defined in advance, and acquires the related data for the identified target data. The correspondence information is information indicating a correspondence between the keyword and the target data. In this case, it is assumed that the correspondence information is stored in the storing unit 103 in advance.

As described above, since the target data of the related data is identified based on the keyword included in the input voice, it is possible to transmit only the information necessary for analyzing the received request or complaint. For that reason, the data size of the related data to be transmitted can be reduced, and a storage capacity of the storing unit 103 required for storing the related data can be reduced.

In this case, the text data converted from the voice data may be transmitted to the support center 2, instead of the voice data, thereby reducing a data communication amount. The text data may be transmitted to the support center 2 as a part of the related data.

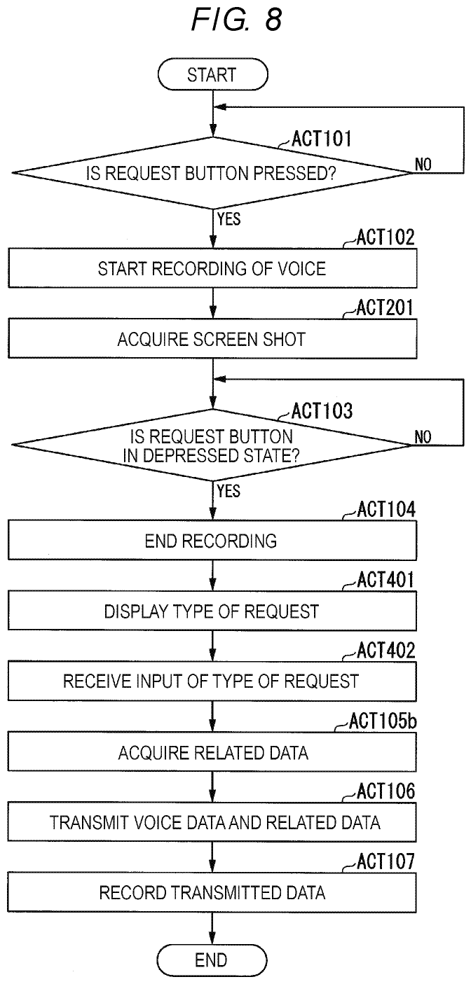

FIG. 8 is a flowchart illustrating a fourth example of the process in which the controller 160 transmits the voice data and the related data to the support center 2 in the image forming apparatus 1 according to the first embodiment. In FIG. 8, the same processes as those in the first flowchart are denoted by the same reference numerals as those in FIG. 5, and the description of the same processes will be omitted.

The fourth flowchart is different from the first flowchart in that the controller 160 causes the display 120 to display a menu screen for allowing the user to input a type (hereinafter referred to as a “type of request”) of a request or complaint to be transmitted to the manufacturer's side (ACT 401). The fourth flowchart is different from the first flowchart in that the controller 160 receives an input of a request type (ACT 402).

In this case, for example, the controller 160 causes the display 120 to display a list of request types defined in advance, and receives an input of an operation of selecting one of the request types. The selection of the request type may be performed at any related timing as long as the related data is not yet acquired.

The fourth flowchart is different from the first flowchart in that the related data is acquired based on the input request type (ACT 105b). For example, the controller 160 identifies target data to be acquired as the related data based on the correspondence information defined in advance, and acquires the related data for the identified target data. The correspondence information in this case is information indicating the correspondence between the request type and the target data. Also, in this case, the correspondence information is stored in the storing unit 103 in advance.

As described above, since the target data of the related data is identified based on the input request type, it is possible to transmit only the information necessary for analyzing the received request or complaint. For that reason, the data size of the related data to be transmitted can be reduced, and the storage capacity of the storing unit 103 required for storing the related data can be reduced.

According to the image forming apparatus 1 of the embodiment configured as described above, the voice data indicating the user request or complaint and the related data corresponding to the timing at which the voice data is acquired are transmitted to the support center 2. With this configuration, on the manufacturer's side of the image forming apparatus 1, it is possible to more promptly respond to the received request or complaint.

### Modification Example

The controller 160 may be configured to hold the voice data or the related data stored in the storing unit 103 for a certain period of time, and delete the data after the certain period of time elapses. With such a configuration, it is possible to reacquire the voice data or related data acquired in the past for a certain period after the acquisition. According to such a configuration, it is possible to suppress exhaustion of an available capacity of the storing unit 103.

The controller 160 may be configured to record a voice at all times. In this case, the controller 160 may be configured to transmit, to the support center 2, the voice data at a timing corresponding to the timing (similar to the related timing) when the request button is depressed. According to such a configuration, since the voice data before the user depresses the request button can be transmitted, on the manufacturer's side, it is possible to check for voice data at a timing closer to the time of occurrence of the malfunction. For that reason, on the manufacturer's side, it is possible to analyze in more detail an event or cause that triggers the user to press the request button.

When the image forming apparatus 1 has a user authentication function, the controller 160 may be configured to start recording according to the timing at which the user logs in to the image forming apparatus 1. In this case, the controller 160 may determine the related timing according to the timing at which the request button is depressed or the timing at which the user logs in to image forming apparatus 1.

### Second Embodiment

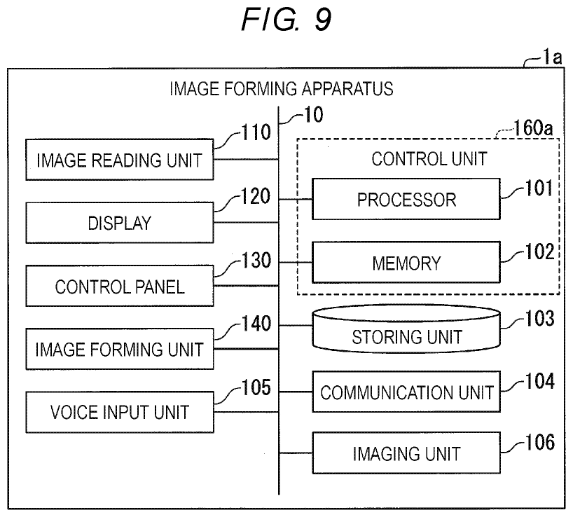

FIG. 9 is a diagram illustrating a configuration of an image forming apparatus 1a according to a second embodiment. The image forming apparatus 1a is different from the image forming apparatus 1 of the first embodiment in that a controller 160a is provided instead of the controller 160. The image forming apparatus 1a is different from the image forming apparatus 1 of the first embodiment in that the image forming apparatus 1a further includes an imaging unit 106. Other configurations of the image forming apparatus 1a are the same as those of the image forming apparatus 1 of the first embodiment. For that reason, in FIG. 9, the same functional units as those in the first embodiment are denoted by the same reference numerals as those in FIG. 3, and the description of the same functional units will be omitted.

The imaging unit 106 is configured using an imaging device (an imaging sensor) such as a camera. The imaging unit 106 is installed at a position and a posture that can image a face of the user who operates the image forming apparatus. The imaging unit 106 outputs image data acquired by imaging to the controller 160a.

The controller 160a has a function of specifying the user who operates the image forming apparatus based on the image data acquired by the imaging unit 106. The controller 160a differs from the controller 160 in the first embodiment in that the controller 160a transmits information (hereinafter, referred to as “user information”) on the specified user to the support center 2 as a part of the related data.

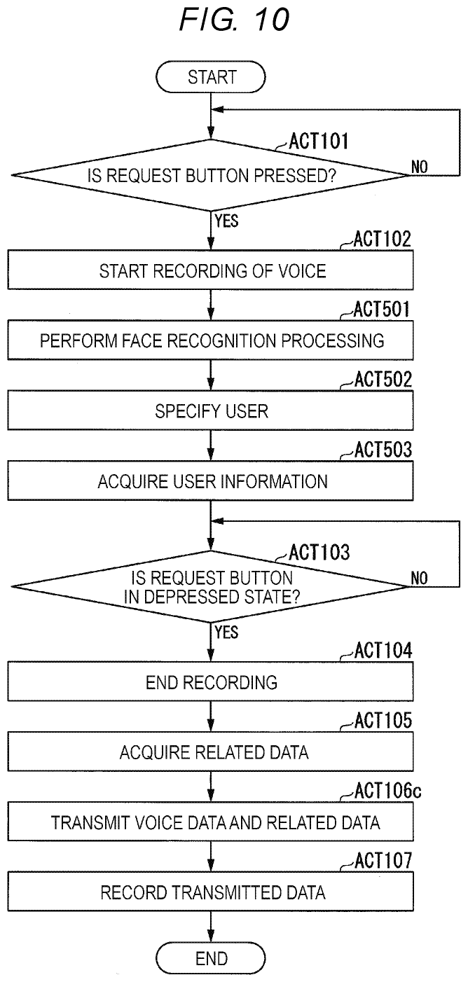

FIG. 10 is a flowchart illustrating an example of a process in which the controller 160a transmits the voice data and the related data to the support center 2 in the image forming apparatus 1a according to the second embodiment. In FIG. 10, the same processes as those in the first flowchart in the first embodiment are denoted by the same reference numerals as those in FIG. 5, and the description of the same processes will be omitted. Hereinafter, the flowchart illustrated in FIG. 10 will be referred to as a fifth flowchart to distinguish the fifth flowchart from the first to fourth flowcharts in the first embodiment.

The fifth flowchart is different from the first flowchart in that the controller 160a performs a process of recognizing a human face from an image based on the image data acquired by the imaging unit 106 (ACT 501). Any technology of the related art may be used for the face recognition process.

In the fifth flowchart, the controller 160a performs a process of specifying a user based on an image (hereinafter, referred to as a “detected image”) of a region detected as a face by the face recognition process (ACT 502). For example, the controller 160a performs pattern matching between a face image (hereinafter, referred to as a “registered image”) of a user registered in advance and the detected image. Based on the result of the pattern matching, the controller 160a determines whether the user, whose image is captured in the detected image, is a user who is registered in advance. In general, the resolution and orientation of the imaged face often differ between the detected image and the registered image. For that reason, the pattern matching in this case may be performed using a feature amount that is strong against rotation, enlargement, or reduction of a subject.

The fifth flowchart further differs from the first flowchart in that the controller 160a acquires user information on the specified user (ACT 503). For example, the controller 160a acquires user information associated with the detected user from among the user information registered in advance. In this case, it is assumed that the storing unit 103 stores user information in advance for each user registered in its own apparatus.

The fifth flowchart further differs from the first flowchart in that the controller 160a transmits the user information of the specified user to the support center 2 as a part of the related data (ACT 106c).

According to the image forming apparatus 1a of the second embodiment configured as described above, the voice data indicating the user request or complaint and information on the user who inputs the voice data can be transmitted to the support center 2 as the related data. For example, by linking information such as the user ID, mail address, and telephone number of each user to the manufacturer's side as the user information, on the manufacturer's side, it is possible to promptly contact the user who depresses the request button. With this configuration, on the manufacturer's side, the reason for depressing the request button and the situation when the request button is depressed can be promptly extracted from the user. For that reason, on the manufacturer's side of the image forming apparatus 1a, it is possible to more promptly respond to the received request or complaint.

When the image forming apparatus 1a according to the second embodiment has a login authentication function based on face authentication, processing of ACT 501 to ACT 503 may be implemented in linkage with the login authentication function.

The support center 2 in the embodiments described above is an example of a system that functions as a department of each manufacturer for receiving the user request or complaint. The support center 2 may be replaced with any other system or device as long as the support center 2 has a role of receiving the user request or complaint.

According to at least one of the embodiments described above, a voice input unit configured to receive a voice around its own apparatus as an input and output a voice signal indicating the voice, a recording unit configured to record the voice signal output during a predetermined first period as voice data, and a controller configured to acquire related data acquired in a second period determined according to the first period and transmit the related data and the voice data to another apparatus are included, thereby being capable of linking information for promptly responding to a user request or complaint regarding the use of the apparatus.

While certain embodiments have been described, these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a voice receiver configured to receive voice data in the vicinity of the image forming apparatus as an input and output a voice signal indicating a voice; and
a controller comprising a processor and a memory, the controller configured to:
record the output voice signal as outputted voice data to the memory during a predetermined first period, and
acquire related data in a second period determined according to the first period; and
a communication interface configured to transmit the related data and the voice data to another apparatus.

2. The image forming apparatus according to claim 1, further comprising:
an input interface configured to receive a first operation input indicating a start timing of the predetermined first period, wherein
the controller is further configured to:
detect the first operation input indicating the start timing, and
begin recording, as the output voice data, the output voice signal at the start timing.

3. The image forming apparatus according to claim 2,
wherein the input interface is further configured to receive a second operation input indicating an end timing of the predetermined first period, and
the controller is further configured to:
detect the second operation input indicating the end timing, and
stop recording the output voice signal at the end timing.

4. The image forming apparatus according to claim 1, wherein the controller is further configured to extract a predetermined keyword from the input voice data; and
the communication interface is further configured to transmit the related data including information related to the keyword and the output voice data to another apparatus.

5. The image forming apparatus according to claim 1, further comprising an imaging sensor configured to acquire image data of a face of a user who operates the image forming apparatus, wherein
the controller is configured to identify the user who generates the voice data based on the image data; and
the communication interface is further configured to transmit the related data including information associated with the identified user and the output voice data to another apparatus.

6. The image forming apparatus according to claim 1, wherein the related data comprises log information and information indicating an input operation of the image forming apparatus performed by a user.

7. The image forming apparatus according to claim 3, wherein the input interface comprises a request button, and
the first operation input comprises depressing the request button once at the start timing, and
the second operation input comprises depressing the request button once at an end timing.

8. The image forming apparatus according to claim 3, wherein the input interface is a request button, and
the first operation input comprises starting depression of the request button at the start timing, and
the second operation input comprises stopping depression of the request button at an end timing.

9. The image forming apparatus according to claim 3, wherein the input interface comprises a switch, and
the first operation input comprises switching the switch to ON at the start timing, and
the second operation input comprises switching the switch to OFF at an end timing.

10. The image forming apparatus according to claim 3, wherein the second period is the same as the first period, and the controller is further configured to:
start acquiring related data at the start timing; and
stop acquiring related data at the end timing.

11. An information transmission method for an image forming apparatus, the method comprising:
receiving, by a voice receiver, voice data generated in the vicinity of the image forming apparatus as an input and outputting a voice signal;
recording, by a controller comprising a processor and a memory, the output voice signal as outputted voice data to the memory during a predetermined first period;
acquiring, by the controller, related data in a second period determined according to the first period, and
transmitting the related data and the outputted voice data to another apparatus.

12. The method according to claim 11, further comprising:
receiving, at a user interface, a first operation input indicating a start timing of the predetermined first period;
detecting, at the controller, the first operation input indicating the start timing, and
starting recording, as the outputted voice data, the output voice signal at the start timing.

13. The method according to claim 12, further comprising:
receiving, at the input interface, a second operation input indicating an end timing of the predetermined first period;
detecting, at the controller, the second operation input indicating the end timing, and
stopping recording, by the controller, the output voice signal at the end timing.

14. The method according to claim 11, further comprising:
extracting, by the controller, a predetermined keyword from the input voice data, and
transmitting, by a communication interface, the related data including information related to the keyword and the voice data to another apparatus.

15. The method according to claim 11, further comprising:
acquiring, by an image sensor, image data of a face of a user operating the image forming apparatus;
identifying, by the controller, the user who generates the input voice data based on the image data, and
transmitting, by a communication interface, the related data including information associated with the identified user and the output voice data to another apparatus.

16. The method according to claim 11, wherein the related data comprises log information and information indicating an input operation of the image forming apparatus performed by a user.

17. The method according to claim 12, wherein the input unit is a request button, the method further comprising:
depressing the request button once at the start timing as the first operation input, and
depressing the request button once at the end timing as the second operation input.

18. The method according to claim 12, wherein the input unit is a request button, the method further comprising:
starting depression of the request button at the start timing as the first operation input, and
stopping depression of the request button at the end timing as the second operation input.

19. The method according to claim 12, wherein the input interface comprises a switch, the method further comprising:
switching the switch to ON at the start timing as the first operation input, and
switching the switch to OFF at the end timing as the second operation input.

20. The method according to claim 13, wherein the second period is the same as the first period, the method further comprising:
starting acquiring related data at the start timing; and
stopping acquiring related data at the end timing.
